(19) United States
(12) Patent Application Publication
(10) Pub. No.: US 2026/0061929 A1
(43) Pub. Date: Mar. 5, 2026

(54) CIRCUIT FILTERING ELECTROMAGNETIC INTERFERENCE

(71) Applicant: Super ATV, LLC, Madison, IN (US)

(72) Inventors: Samuel James Fastle, La Grange, KY (US); Bradford James Hood, Crothersville, IN (US)

(73) Assignee: Super ATV, LLC, Madison, IN (US)

(21) Appl. No.: 18/820,971

(22) Filed: Aug. 30, 2024

(51) Int. Cl. B60Q 1/00; B60Q 1/34

(52) U.S. Cl. CPC B60Q 1/0088; B60Q 1/34; H02M 1/44

(57) ABSTRACT

A circuit designed to protect a system from interference. In one example, the system includes a physical switch, a microcontroller, and the circuit. The physical switch is configured to generate and send an electrical signal to the microcontroller. The circuit is configured to filter interference from the electrical signal. The circuit includes an input filter, a switch, and an output filter. The input filter and output filter allow the circuit to filter interference effectively without causing delay in between inputs from the physical switch to the microcontroller. In one example, the input filter and output filter are configured to filter interference caused by electromagnetic radiation.

### BACKGROUND

The present disclosure relates to conducting signals between components in a system.

Many systems commonly include electronic components that send and receive electrical signals. Electrical signals typically include signals that represent data, commands, and/or other types of control signals. For example, such electrical components may include a controller, computer, processor, and/or another device that can interpret, modify, redirect, and/or perform other tasks based on the electrical signals. Additionally, such components may include input and/or output devices, such as display devices, electric motors, sensors, input devices, and/or other devices that can generate or receive an electrical signal.

In some cases, an electrical signal can become distorted and/or altered between a component that sends the signal and a component that receives the signal. In such cases, the component receiving such a signal may operate and/or interpret the signal in a different way than intended. For example, a component may typically operate in a specific way when the component receives an electrical signal in an ideal form. Alternatively, if the electrical signal becomes distorted and/or altered, the component may instead operate in a completely different and/or unexpected way upon receiving the electrical signal. Systems that are susceptible to electrical signal distortion and/or alteration may limit or fully prevent users from utilizing the system as intended.

There is a need for a signal protection circuit. This can be accomplished through a combination of several design features described below.

### BRIEF DESCRIPTION OF THE DRAWINGS

FIG. 1 is a block diagram of a system according to one embodiment.

FIG. 2 is a block diagram of a circuit, a component of the FIG. 1 system.

FIG. 3 is a schematic of the FIG. 2 circuit according to one embodiment.

FIG. 4 is a schematic of the FIG. 2 circuit according to another embodiment.

FIG. 5 is a block diagram of a kit implementing the FIG. 1 system according one embodiment.

FIG. 6 is block diagram of the FIG. 5 kit installed on the FIG. 1 system according to another embodiment.

FIG. 7 is a block diagram of the FIG. 5 kit according to another embodiment.

### DESCRIPTION OF THE SELECTED EMBODIMENTS

For the purpose of promoting an understanding of the principles of the claimed invention, reference will now be made to the embodiments illustrated in the drawings and specific language will be used to describe the same. It will nevertheless be understood that no limitation of the scope of the claimed invention is thereby intended. Any alterations and further modifications in the described embodiments, and any further applications of the principles of the claimed invention as described herein are contemplated as would normally occur to one skilled in the art to which the claimed invention relates. One embodiment of the claimed invention is shown in great detail, although it will be apparent to those skilled in the relevant art that some features that are not relevant to the present claimed invention may not be shown for the sake of clarity.

With respect to the specification and claims, it should be noted that the singular forms “a”, “an”, “the”, and the like include plural referents unless expressly discussed otherwise. As an illustration, references to “a device” or “the device” include one or more of such devices and equivalents thereof. It also should be noted that directional terms, such as “left”, “right”, “up”, “down”, “top”, “bottom”, and the like, are used herein solely for the convenience of the reader in order to aid in the reader's understanding of the illustrated embodiments, and it is not the intent that the use of these directional terms in any manner limit the described, illustrated, and/or claimed features to a specific direction and/or orientation.

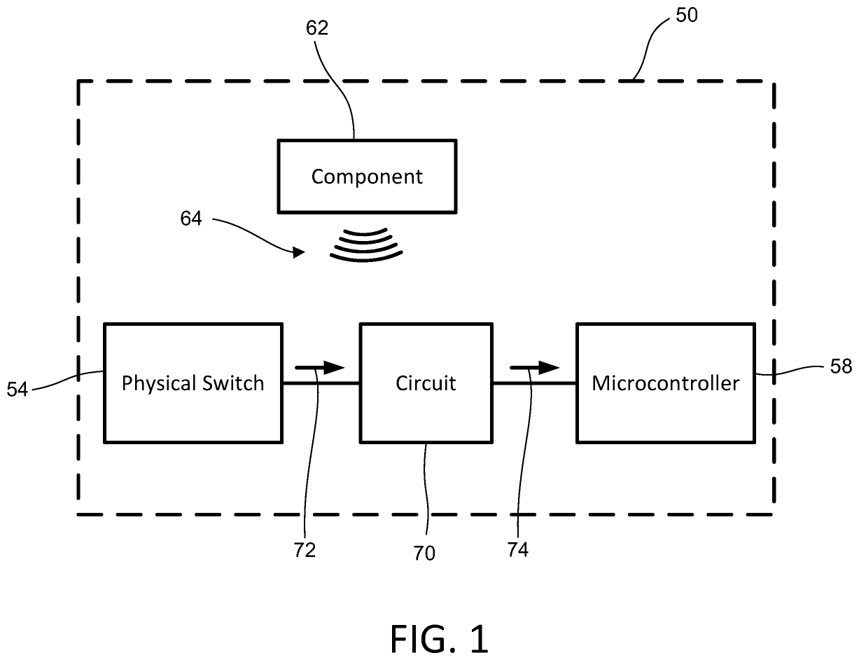

Referring to FIG. 1, a diagram of a system 50 is shown according to one embodiment. In one example, system 50 can include a vehicle, such as an all-terrain vehicle (ATV) and/or a utility task vehicle (UTV) as examples. A vehicle in system 50 may further include lights, such as light emitting diodes (LEDs), utilized as turn signals, headlights, brake lights, and/or in another way. Alternatively, system 50 could be utilized in a variety of other applications, such as in manufacturing equipment, medical devices, radio transmitter/receiver modules, and/or power conversion devices as examples.

In the illustrated embodiment, system 50 generally includes a physical switch 54, a microcontroller 58, and a circuit 70. Physical switch 54 generally allows a user to control an input to microcontroller 58. Microcontroller 58 is generally configured to control one or more devices in vehicle 50 based on the user input. Circuit 70 electrically connects physical switch 54 to microcontroller 58. In one embodiment, physical switch 54, microcontroller 58, and circuit 70 are utilized to allow a user to control lights in system 50, such as turn signals, headlights, and/or brake lights on a vehicle. Further, circuit 70 can be configured to modify the user input to facilitate reliable operation of system 50. For example, circuit 70 can be configured to filter electromagnetic interference and/or other noise from a control signal. As should be appreciated, system 50 could include one or more alternative devices in addition to or in place of physical switch 54 and/or microcontroller 58.

Circuit 70 is electrically connected to physical switch 54 at one node and electrically connected to microcontroller 58 at another node. Generally, an electrical node refers to a portion of a circuit where the voltage at each physical point is substantially the same. For example, a node can include multiple physical points of a circuit that are shorted together and/or connected through low resistance. Typically, a node can include the junction between two or more electrical components. In some instances, a node can include cables, connectors, wires, busbars, and/or other electrical conductors that have low or negligible resistance and/or that connect multiple components.

Physical switch 54 can include a selector switch, button, knob, and/or another type of device that allows a user to selectively connect two or more electrical nodes. In one example, physical switch 54 can be a rocker switch that allows a user to flip between two or more positions. Physical switch 54 can be configured to selectively connect circuit 70 and another device, such as a voltage source. For instance, physical switch 54 may be electrically connected to circuit 70 on one node and electrically connected to a battery, power converter, and/or other power source at another node. In such an example, physical switch 54 may be flipped between a closed position and an open position. A user may flip physical switch 54 into a closed position to connect such nodes and into an open position to disconnect such nodes. As should be appreciated, physical switch 54 could be a single pole switch with multiple throws. For example, switch 54 could be used to selectively connect a first node to one of multiple other nodes. Alternatively, physical switch 54 could be electrically connected to another device that generates an electrical signal, such as a sensor, a signal generator, and/or another microcontroller as examples.

Physical switch 54 generally allows a user to produce and/or modify an electrical signal through user input. An electrical signal generally refers to information that is transmitted through a voltage, current, and/or electromagnetic wave as examples. An electrical signal can be an analog signal that can vary continuously within a range of values. Alternatively, an electrical signal can be a digital signal that can vary between discrete states. In one example, a digital signal can include a voltage that varies between a high state and a low state to represent binary data. Further, digital signals may include a rising edge and a falling edge. The rising edge denotes the point in time where the signal transitions from a low state to a high state. The falling edge denotes the point in time where the signal transitions from a high state to a low state. Typically, an electrical signal can be represented by a waveform that describes how the electrical signal varies over time. Such a waveform may include measurable characteristics such as a frequency and/or amplitude. In some cases, an electrical signal can include noise and/or random data that distorts and/or alters the waveform of the electrical signal.

As illustrated, physical switch 54 is generally configured to transmit a circuit input signal 72 to circuit 70. Circuit input signal 72 can contain information about an input from the user. In one example, circuit input signal 72 can be a digital voltage signal that varies between high and low states. For instance, a user can change circuit input signal 72 to a high state by flipping physical switch 54 to a closed position. Conversely, the user can change circuit input signal 72 to a low state by flipping physical switch 54 to an open position. By varying between high and low states, circuit input signal 72 can indicate user inputs to activate or deactivate a device. For example, in a high state, circuit input signal 72 may indicate an input to activate a turn signal and/or another device.

Microcontroller 58 can include a processor, computer, controller, and/or another such device. Typically, microcontroller 58 can be configured to send and receive electrical signals, perform computations and/or logical operations based on electrical signals, store information, and/or perform other functions. In one embodiment, microcontroller 58 can be electrically connected to one or more devices in system 50 and/or can be configured to send commands in the form of electrical signals to one or more devices in system 50. Compared to using only relays or another such device to operate components in system 50, microcontroller 58 can operate devices while providing more complex and customizable controls.

As illustrated, microcontroller 58 is configured to receive a circuit output signal 74 from circuit 70. Circuit output signal 74 can contain the same information about a user input as contained in circuit input signal 72. For instance, a high state of circuit output signal 74 may represent a user input to activate a device. Typically, microcontroller 58 is configured to interpret and/or process circuit output signal 74. For example, microcontroller 58 may interpret an input to activate or deactivate a device based on circuit output signal 74. Microcontroller 58 may then send commands to that device to control the device based on the user input. In other systems, physical switch 54 is connected to a relay and/or another such device that then sends a control signal to the device. Using microcontroller 58 instead of a relay allows system 50 to control devices in a variety of ways. For example, microcontroller 58 can control the device to perform a series of operations after receiving circuit output signal 74 in a high state. For instance, microcontroller 58 may flash a turn signal for a number of flashes after observing circuit output signal 74 in a high state. Conversely, a relay may simply turn the device on when circuit output signal 74 is high and off when circuit output signal 74 is low. In this way, microcontroller 58 allows devices in system 50 to perform specialized functions. Further, compared to using relays, microcontroller 58 allows the devices to operate in more complex ways based on single user inputs.

Circuit 70 is configured to receive circuit input signal 72 and to transmit circuit output signal 74. Generally, circuit 70 is configured to modify circuit input signal 72 to ensure that user inputs are reliably communicated to microcontroller 58. In one example, microcontroller 58 may not be able to effectively interpret circuit input signal 72 due to distortion and/or noise. For instance, distortions and/or noise could be caused by electromagnetic interference and/or switch bouncing. Distortions may cause microcontroller 58 to interpret a signal state as high when the signal state should be low, and/or vice-versa. Circuit 70 can modify circuit input signal 72 to remove the distortions and then send circuit output signal 74 to microcontroller 58. Microcontroller 58 may then be able to effectively interpret circuit output signal 74 which is substantially free of distortion and/or noise. As should be appreciated, circuit 70 could be connected to any type of devices. In one example, circuit 70 can receive circuit input signal 72 from any type of device that can send a signal, such as a sensor and/or another microcontroller as examples. In another example, circuit 70 can send circuit output signal 74 to another device, such as a light, relay, actuator, and/or output device as examples.

In the illustrated embodiment, system 50 further includes an additional component 62. Component 62 can be a device controlled by a user through microcontroller 58, or can operate independently and/or indirectly from user inputs. In one example, component 62 is an automobile horn. As shown, component 62 can be configured to emit electromagnetic waves 64. Component 62 may emit electromagnetic waves 64 at the time component 62 operates, when component 62 is powered on, and/or in other circumstances. In one example, component 62 can produce a sound when operating, and a frequency of electromagnetic waves 64 is the same as a frequency of the sound produced by component 62.

Electromagnetic waves 64 may produce electromagnetic interference (EMI) on circuit input signal 72. In other words, electromagnetic waves 64 may create a change in a voltage and/or current of circuit input signal 72 through inductive coupling, capacitive coupling, and/or as radiation. EMI can add noise to and/or distort circuit input signal 72. Such noise and/or distortion generally impacts the function of one or more devices in system 50. Typically, the EMI can cause the devices to operate in a way not intended by a user. In one example, electromagnetic waves 64 may cause one or more spikes or impulses in circuit input signal 72 and/or in circuit output signal 74. Microcontroller 58 may interpret such a spike or impulse as an input to activate another component in system 50. For instance, honking an automobile horn may cause lights to activate unintentionally. In another example, component 62 can cause interference on circuit input signal 72 through an electrical conduction path between physical switch 54 and component 62.

In one example, component 62 may produce a current and/or voltage after a user powers off component 62. Such current and/or voltage may cause interference on circuit 70. For instance, the current and/or voltage may cause component 62 to emit electromagnetic waves 64 which induce EMI and/or may cause interference through a conduction path in system 50. In the example where component 62 is a horn, a membrane on the horn may continue to vibrate after the horn is powered off. Such vibrations of the membrane may generate a current through the horn, such as through inductors in the horn. Alternatively, current in the inductors of the horn may dissipate for a period of time after the horn is powered off. Current generated in this way may dissipate as electromagnetic waves 64 and/or may flow into other parts of system 50 as interference. In some cases, component 62 still causes EMI and/or other interference when additional circuitry is connected to component 62. For instance, it was observed that connecting a diode to component 62 only prevented EMI generation in some test cases.

Circuit 70 is generally configured to filter EMI caused by electromagnetic waves 64. By filtering EMI from circuit input signal 72, circuit 70 can ensure reliable operation of system 50. It was observed that filtering EMI through circuit 70 was more effective than other measures to prevent EMI generation, such as one or more diodes connected to component 62. Compared to using relays or other such devices, microcontroller 58 can be more sensitive to distortions caused by EMI. For instance, a spike or impulse on circuit input signal 72 caused by EMI may result in a relay activating a device for a brief or unnoticeable time. However, microcontroller 58 may initiate a series of operations on the device in response to spikes and/or impulses on circuit input signal 72. Even if EMI causes a brief impulse on circuit input signal 72, microcontroller 58 may operate the device in a way that lasts for a longer period and/or that is noticeable to the user. In one example, the EMI may affect how lights in system 50 are operated, such as turn signals, headlights, and/or hazard lights. Using relays, the lights may activate only for the duration of an impulse caused by EMI. Conversely, microcontroller 58 may cause the lights to flash repeatedly for a number of flashes in response to such an EMI impulse.

In another embodiment, circuit 70 is further configured to filter bounce oscillations caused by physical switch 54. When a user flips physical switch 54, electrical contacts in physical switch 54 may unintentionally bounce out of contact and back into contact one or more times. Therefore, if a user flips physical switch 54 once, bouncing may cause the circuit input signal 72 to oscillate between a high state and a low state multiple times. The bounce oscillations can generally refer to the unintentional oscillations between high and low states when a user flips switch 54. The bounce oscillations can cause microcontroller 54 to misinterpret a user input. For example, a user may intend to activate a device by flipping switch 54, but due to bounce oscillations, microcontroller 58 may interpret multiple inputs to activate and deactivate the device. In such an example, microcontroller 58 may initiate multiple instances of a series of operations on the device. As with EMI, using microcontroller 58 can make system 50 more sensitive to bounce oscillations compared to using relays or other such devices. By filtering bounce oscillations from circuit input signal 72, circuit 70 can ensure reliable communication of user inputs between switch 54 and microcontroller 58.

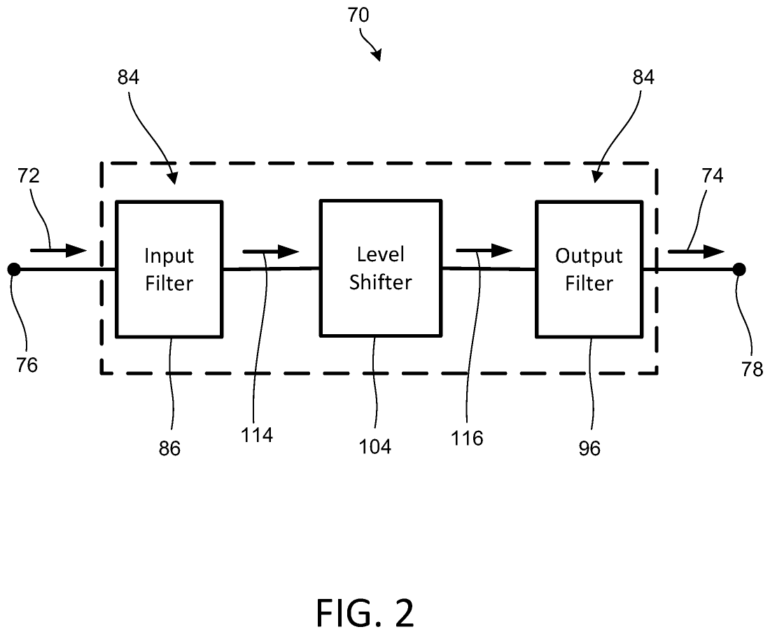

Referring to FIG. 2, a block diagram of circuit 70 is shown. As illustrated, circuit 70 extends between an input node 76 and an output node 78. Circuit 70 generally includes one or more filters 84 and a level shifter 104. Filters 84 are generally configured to filter noise and/or distortions from electrical signals in circuit 70. Filtering can refer to reducing or fully removing noise and/or distortions from the electrical signals. For instance, effective filtering may reduce an amplitude of the noise below a certain percentage of an amplitude of the electrical signal, such as below 10 percent, 5 percent, 1 percent, and/or lower. In one example, filters 84 may remove noise and/or distortions caused by EMI, bounce oscillations, and/or other interference as examples. Level shifter 104 is generally configured to adjust a voltage level of an electrical signal in circuit 70. For example, microcontroller 58 is configured to receive electrical signals at a certain voltage level, and level shifter 104 may adjust a voltage level of the electrical signal toward the desired voltage level of microcontroller 58.

As shown, filters 84 in circuit 70 generally include an input filter 86 and an output filter 96. Input filter 86 is connected between input node 76 and level shifter 104. Output filter 96 is connected between level shifter 104 and output node 78. Input filter 86 and output filter 96 are configured to filter interference out of circuit input signal 72. In one example, filters 84 are low-pass filters configured to filter interference above a certain frequency. For instance, filters 84 are configured to filter interference at frequencies above 100 hertz, 200 hertz, 400 hertz, and/or another frequency. Compared to a band-stop filter configured to filter frequencies within a certain range, the low-pass filter protects against interference in a larger range of frequencies. Further, the low-pass filter may be physically smaller, involve fewer parts, and/or work more reliably than a band-stop filter. In another example, filters 84 may include a bandpass filter configured to filter interference outside a desired frequency range.

Using both input filter 86 and output filter 96 can ensure that interference is completely or nearly completely removed from circuit output signal 74. Input filter 86 and output filter 96 together are configured to consistently and reliably filter interference from circuit 70. Although input filter 86 and output filter 96 each may filter out some interference, the combination of both filters 84 enables circuit 70 to reliably and effectively remove interference. It was observed that using only one filter worked only part of the time to filter out interference. For instance, it was observed that using only one filter which was positioned on output node 78 only effectively filtered interference in 50 percent of test cases. However, when both input filter 86 and output filter 96 were used together, it was observed that circuit 70 consistently and effectively filtered out interference.

Using a single filter may not be as effective as both filters 84. Specifically, a single filter refers to using only one filter positioned either at input node 76 or at output node 74. For example, a single filter may only be configured to effectively filter interference at an amplitude below a certain threshold and/or at a frequency within a certain range. The single filter may only effectively filter interference in 50 percent, 25 percent, and/or fewer of the cases where the interference would affect circuit 70. Conversely, input filter 86 and output filter 96 together are configured to effectively filter interference in all or nearly all cases where the interference would affect circuit 70.

Input filter 86 and output filter 96 are further configured to support quick response times of system 50. Filters generally cause some delay in an electrical signal. In one example, the total delay caused by input filter 86 and output filter 96 is negligible and/or not noticeable by a user. For instance, the total delay is typically less than 100 milliseconds. In another example, the total delay can be less than 200 milliseconds, 150 milliseconds, 50 milliseconds, and/or another amount of time. It was observed that using only one filter caused significant delay in the response time of system 50 to a user input. In one example, it was observed that using only one filter which was positioned on input node 76 caused significant delay. In another example, it was observed that using only one filter which was positioned on output node 78 similarly caused significant delay. In such tests, the delay when using a single filter was noticeable to a user and affected performance of the system. In some cases, the delay when using a single filter can be greater than 200 milliseconds, 500 milliseconds, or another amount. Conversely, it was observed that using both input filter 86 and output filter 96 reduced delay to the point it was not noticeable to the user. Input filter 86 and output filter 96 together were able to effectively and consistently filter interference without causing a significant or noticeable delay.

Although input filter 86 and output filter 96 each cause some delay, the total delay across both filters 84 can be lower than the delay using a single filter in circuit 70. In one example, input filter 86 and output filter 96 are configured to effectively filter interference using one or more types of circuit arrangements. For instance, input filter 86 and output filter 96 are able to utilize certain circuit topologies and/or ranges of circuit component values. Conversely, a single filter may not be able to effectively filter interference using the same types of circuit arrangements as input filter 86 and/or output filter 96. Therefore, the single filter typically must utilize a different circuit arrangement. Such a circuit arrangement used in a single filter can cause noticeable delays in electrical signals. For instance, it was observed that one type of filter could normally block interference when used as a single filter only on input node 76. However, it was observed that such a filter consistently caused a significant delay. Using both filters 84 can be both more effective at filtering interference and can result in lower overall delay compared to using a single filter.

In one example, delay generally refers to the amount of time between a rising/falling edge observed on circuit input signal 72 and a corresponding rising/falling edge observed on circuit output signal 74. The rising/falling edge on circuit input signal 72 generally indicates the instance when a user enters an input. The rising/falling edge on circuit output signal 74 generally indicates the instance when microcontroller 58 receives and/or observes an input. In some cases, filters smooth the rising/falling edges of an electrical signal. In one example, the delay between the rising/falling edges on circuit output signal 74 and on circuit input signal 72 is caused by smoothing the rising and/or falling edges of circuit output signal 74. Smoothing the rising/falling edges typically increases the time the electrical signal takes to transition from a low state to a threshold value for a high state, and/or vice-versa. In this way, the smoothed edges of an electrical signal can cause a delay in microcontroller 58 and/or another device observing the rising and/or falling edge.

Input filter 86 and output filter 96 can affect the rising and/or falling edges of circuit input signal 72 to a lesser extent than a single filter configuration. As noted, a single filter typically utilizes a different circuit topology and/or circuit component values than the input filter 86 and/or output filter 96. In one example, a single filter defines a cutoff frequency that is lower than a cutoff frequency of input filter 86 and output filter 96. The cutoff frequency generally refers to a frequency at which a filter reduces an amplitude of an electrical signal below a threshold, such as below 70%, 50%, and/or another proportion of an amplitude of the unfiltered signal. In a low-pass filter, frequencies above the cutoff frequency are attenuated in this way or to a greater extent. By defining a low cutoff frequency, the single filter may filter part of circuit input signal 72 and smooth the rising/falling edges of circuit input signal 72. Conversely, first filter 86 and second filter 96 generally define a cutoff frequency substantially above a frequency circuit input signal 72 so as to mitigate or fully avoid smoothing the rising/falling edges.

In another example, a single filter defines a less steep roll-off than input filter 86 and output filter 96. The roll-off generally refers to the rate that a filter attenuates signals with respect to frequency of the signal. Steep roll-off allows a filter to significantly reduce the amplitude of signals at frequencies above a cutoff frequency without affecting signals at frequencies below the cutoff frequency. Using a single filter with a less steep roll-off generally affects circuit output signal 74 and smooths the rising/falling edges. In one example, input filter 86 and output filter 96 together function as a multi-order filter with steep roll-off. For instance, input filter 86 and output filter 96 can each be single-order filters but can form a second-order filter when used together. The steep roll-off allows filters 84 to effectively filter interference without significantly smoothing circuit output signal 74. The roll-off and/or cutoff frequency characteristics allow the input filter 86 and output filter 96 to effectively filter interference without causing noticeable delay in circuit output signal 84.

As shown, level shifter 104 is configured to receive a switch control signal 114 and to produce a switch output signal 116. Level shifter 104 is configured to adjust a voltage level of circuit input signal 72 such that circuit output signal 74 is at a different voltage level than circuit input signal 72. Specifically, level shifter 104 is configured to adjust a voltage level of switch control signal 114. In one embodiment, level shifter 104 can adjust a voltage level of switch control signal 114 to be at a voltage level accepted by microcontroller 58. In one example, a voltage of switch control signal 114 may be based on a battery in system 50, and level shifter 104 can adjust the voltage to a usable voltage level for microcontroller 58. For instance, a battery voltage may be 12 volts, and a usable voltage for microcontroller 58 may be 5 volts. Using a lower voltage on microcontroller 58 compared to a voltage at physical switch 54 may make microcontroller 58 sensitive to EMI and/or other interference. Compared to using relays or other such devices that operate at the same voltage level as physical switch 54, using microcontroller 58 at a lower voltage level can make system 50 more sensitive. Typically, a voltage level of an interference signal is lower compared to the relay voltage level than a voltage level used by microcontroller 58. In one example, the interference signal may be at such a voltage level that microcontroller 58 mistakes the interference as a user input. Conversely, the same interference signal may not affect a relay.

Further, level shifter 104 may function as a buffer between switch control signal 114 and switch output signal 116. For example, level shifter 104 may prevent or heavily limit current flow between switch control signal 114 and switch output signal 116. As should be appreciated, level shifter 104 could be configured to increase or decrease a voltage level of control signal 114. Alternatively, level shifter 104 could maintain substantially the same voltage level between control signal 114 and output signal 116.

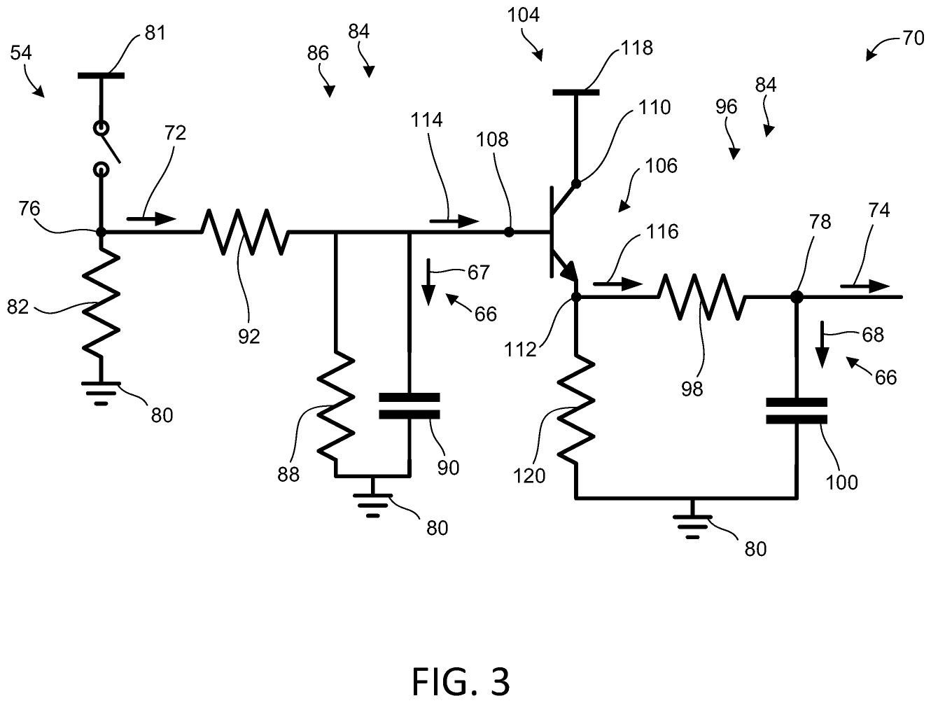

FIG. 3 shows a schematic of one embodiment of circuit 70. As shown, circuit 70 generally includes a ground node 80, an input voltage source 81, and an input resistor 82. Ground node 80 may extend across a large physical area. For example, ground node 80 may include and/or be electrically connected to the chassis of a vehicle. A voltage at ground node 80 is generally a reference for a voltage on any other electrical signal in system 50.

Input voltage source 81 can be electrically connected to physical switch 54. As shown, physical switch 54 can be connected between voltage source 81 and circuit input node 76. A user can produce circuit input signal using physical switch 54 by selectively connecting or disconnecting voltage source 81 to circuit input node 76. Input voltage source 81 can include and/or be electrically connected to a battery, a power converter, and/or another device in system 50. Input resistor 82 is connected between circuit input node 76 and ground node 80. Input resistor 82 generally functions as a pull-down resistor. Input resistor 82 can support a voltage difference between circuit input node 76 and ground node 80 when physical switch 54 is closed. Conversely, input resistor 82 can effectively set a voltage at circuit input node 76 to the voltage at ground node 80 when physical switch 54 is open.

As illustrated, circuit 70 may carry an interference signal 66 along one or more portions of circuit 70. As shown in FIG. 1, electromagnetic waves 64 may at least partially cause interference signal 66. In one example, electromagnetic waves 64 can propagate from component 62 and/or another source. Circuit 70 may receive and convert electromagnetic waves 64 into interference signal 66, similar to an antenna and/or other wireless receiver. In another example, electromagnetic waves 64 can be in the form of an electric and/or magnetic field, and electromagnetic waves 64 may produce interference signal 66 in circuit 70 through inductive and/or capacitive coupling. As should be appreciated, interference signal 66 could be caused at least partially through a conductive path between circuit 70 and component 62. Interference signal 66 typically has a higher frequency than circuit input signal 72 and/or circuit output signal 74. In one example, a frequency of interference signal 66 is at least 100 hertz, 200 hertz, 400 hertz, and/or another frequency.

Circuit 70 may receive interference signal 66 as multiple electrical signals, such as an input interference signal 67 and an output interference signal 68. In one example, electromagnetic waves 64 may arrive at multiple points on circuit 70, such as at an input side and at an output side of circuit 70. Circuit 70 may receive electromagnetic waves 64 on the input side as input interference signal 67, and may receive electromagnetic waves 64 on the output side as output interference signal 68. In one example, input interference signal 67 may be distinct from output interference signal 68. For instance, the phase, amplitude, frequency, and/or other characteristics may differ between input interference signal 67 and output interference signal 68. In another example, input interference signal 67 can flow through a conductive path into an input side of circuit 70, and output interference signal 68 can flow through another conductive path into an output side of circuit 70. In yet another example, input interference signal 67 can include output interference signal 68, and output interference signal 68 can be a residual portion of input interference signal 67.

Level shifter 104 generally separates an input side and an output side of circuit 70. In the illustrated embodiment, level shifter 104 includes a switch 106. Switch 106 is generally configured to selectively allow current flow between two nodes based a control input. Typically, switch 106 is an electronic switch such as a transistor. In one example, switch 106 can include a solid-state device, such as a bipolar junction transistor (BJT), metal-oxide-semiconductor field-effect transistor (MOSFET), insulated gate bipolar transistor (IGBT), thyristor, and/or anther semiconductor device. Alternatively, switch 106 could include a solid-state relay, an electromechanical relay, and/or another device.

As illustrated, switch 106 includes a control node 108, input node 110, and output node 112. In a closed state, switch 106 is generally configured to allow current flow between input node 110 and output node 112. For example, switch 106 is configured to form a closed circuit between input node 110 and output node 112 in a closed state. Conversely, in an open state, switch 106 is configured to block current flow between input node 110 and output node 112. Switch 106 can flip between states based on switch control signal 114 received at control node 108. For example, switch 106 can be in a closed state when a voltage level at control node 108 is above a threshold value, such as when switch control signal 114 is in a high state. Similarly, switch 106 can be in an open state when a voltage level at control node 108 is below the threshold value, such as when switch control signal 114 is in a low state.

Lever shifter 104 generally further includes a voltage source 118 and an output resistor 120. Voltage source 118 can include and/or be electrically connected to a battery, a power converter, and/or another device in system 50. Voltage source 118 is connected to the input node 110 on switch 106. When switch 106 is in a closed state, output node 112 is electrically connected to voltage source 118. In one example, voltage source 118 is at a voltage level used by microcontroller 58. Level shifter 104 is configured to produce switch output signal 116 by converting a voltage level of switch control signal 114 to a voltage level of voltage source 118. Specifically, switch 106 is configured to lower a voltage level of switch output signal 116 relative to a voltage level of switch control signal 114. Output resistor 120 generally functions as a pull-down resistor. Output resistor 120 can support a voltage difference between switch output node 112 and ground node 80 when switch 106 is closed. Conversely, output resistor 120 effectively sets a voltage at switch output node 112 to the voltage at ground node 80 when switch 106 is open.

Input filter 86 is connected between circuit input node 76 and switch control node 108. Input filter 86 is configured to partially or fully filter interference signal 66 from circuit input signal 72. Specifically, input filter 86 can filter input interference signal 67. Input filter 86 is configured to pass switch control signal 114 to switch control node 108. In one example, a frequency of input interference signal 67 is greater than a frequency of switch control signal 114. In such an example, the frequency of switch control signal 114 is lower than a cutoff frequency of input filter 86, and the frequency of input interference signal 67 is greater than the cutoff frequency. Typically, circuit input signal 72 includes switch control signal 114. In one example, circuit input signal 72 is a sum of voltages and/or currents of switch control signal 114 and input interference signal 67. In another example, switch control signal 114 may include reduced and/or residual portions of input interference signal 67 that are not completely filtered by input filter 86. By filtering input interference signal 67 from circuit input signal 72, input filter 86 can ensure that control signal 114 is substantially free of distortion and/or noise.

In the illustrated embodiment, input filter 86 includes a resistor 88 and capacitor 90. In one example, resistor 88 and capacitor 90 are connected in parallel. As illustrated, resistor 88 and capacitor 90 are each connected between control node 108 and ground node 80. Positioning resistor 88 and capacitor 90 between control node 108 and ground node 80 allows input interference signal 67 to travel to ground node 80 while allowing switch control signal 114 to pass to control node 108. Input filter 86 is typically a low-pass filter configured to filter frequencies above a certain threshold. In one example, the cutoff frequency is less than or equal to 100 hertz, 200 hertz, 400 hertz, and/or another frequency. Capacitor 90 can be set to a variety of values, such as a value less than or equal to 5 microfarads, 1 microfarad, 100 nanofarads, and/or another capacitance. In one example, input filter 86 includes only one capacitor 90 and forms a first-order filter. Using only one capacitor 90 allows input filter 86 to utilize a small number of parts and to be manufactured effectively. Alternatively, input filter 86 could include more than one capacitor 90 to form a higher order filter with a steeper roll-off. Further, using capacitor 90 in input filter 86 is smaller and/or more power efficient than using an inductor and/or another component. As should be appreciated, input filter 86 could include different electrical components and/or be arranged in a different topology.

Input filter 86 optionally further includes a shunt resistor 92. Shunt resistor 92 is configured to reduce a voltage level of circuit input signal 72. For example, shunt resistor 92 and resistor 88 are configured to divide a voltage of circuit input signal 72. By dividing the voltage, shunt resistor 92 also reduces a voltage amplitude of input interference signal 67. The reduced voltage of input interference signal 67 limits the impact of input interference signal 67 on circuit 70 and/or allows input interference signal 67 to be filtered more completely. In one example, shunt resistor 92 facilitates level shifter 104 by lowering a voltage level of circuit input signal 72.

Output filter 96 is connected between switch output node 112 and circuit output node 78. Output filter 96 is configured to partially or fully filter interference signal 66 from switch output signal 116. Specifically, output filter 96 is configured to filter output interference signal 68. Output filter 96 is configured to pass circuit output signal 116 to circuit output node 78. In one example, a frequency of output interference signal 68 is greater than a frequency of circuit output signal 74. In such an example, the frequency of circuit output signal 74 is lower than a cutoff frequency of output filter 96, and the frequency of output interference signal 68 is greater than the cutoff frequency. In another example, a frequency of output interference signal 68 is lower than a frequency of input interference signal 67. Typically, switch output signal 116 includes circuit output signal 74. In one example, switch output signal 116 is a sum of voltages and/or currents of circuit output signal 74 and output interference signal 68. By filtering output interference signal 68 from switch output signal 116, output filter 96 ensures that circuit output signal 74 is substantially free of distortion and/or noise.

In one example, interference signal 66 may be present in switch output signal 116 but not in circuit input signal 72. For example, interference signal 66 may only travel through level shifter 104 and/or output filter 96. In such an example, output filter 96 may filter interference signal 66 from switch output signal 116, but input filter 86 may not need to filter interference signal 66 from circuit input signal 72. In one example, electromagnetic waves 64 cause interference signal 66 to enter circuit 70 at both input and output sides. In another example, component 62, shown in FIG. 2, may draw substantial current from battery and/or another voltage source in system 50 when operating. Such current may cause fluctuations and/or other distortions in voltage source 118 at input node 110 of switch 106 and/or otherwise cause voltage source 118 to momentarily be unstable. In one example, component 62 can be an automobile horn, and fluctuations in voltage source 118 can be at the same frequency as a sound produced by the horn. The fluctuations and/or distortions in voltage source 118 may produce interference in switch output signal 116. Conversely, circuit 70 may be configured to receive interference signal 66 only at circuit input node 76. In one example, input filter 86 may completely or nearly completely filter interference signal 66 from circuit input signal 72, and output filter 96 may not need to filter interference signal 66 from switch output signal 116.

In the illustrated embodiment, output filter 96 includes a resistor 98 and capacitor 100. In one example, resistor 98 and capacitor 100 are connected in series. As illustrated, resistor 98 is connected between switch output node 112 and circuit output node 78, and capacitor 90 is connected between circuit output node 78 and ground node 80. Positioning capacitor 100 between circuit output node 78 and ground node 80 allows output interference signal 68 to travel to ground node 80 while allowing circuit output signal 74 to pass to circuit output node 78. Output filter 96 is typically a low-pass filter configured to filter frequencies above a certain threshold. In one example, the cutoff frequency is less than or equal to 100 hertz, 200 hertz, 400 hertz, and/or another frequency. In another example, the cutoff frequency of output filter 96 is lower than the cutoff frequency of input filter 86. Using a lower cutoff frequency allows output filter 96 to filter interference that may have passed through input filter 86. In one example, the cutoff frequencies of both input filter 86 and output filter 96 are below 200 hertz.

Capacitor 100 may be set to a variety of values, such as a value less than or equal to 10 microfarads, 5 microfarads, 1 microfarad, 100 nanofarads, and/or another capacitance. In one example, output filter 96 includes only one capacitor 100 and forms a first-order filter. Using only one capacitor 100 allows output filter 96 to utilize a small number of parts and to be manufactured quickly. Alternatively, output filter 96 could include more than one capacitor 100 to form a higher order filter with a steeper roll-off. Further, using capacitor 100 in output filter 96 is smaller and/or more power efficient than using an inductor and/or another component. In one example, resistor 98 functions similarly to shunt resistor 92 in input filter 86. For instance, resistor 98 may be configured to reduce a voltage level of switch output signal 116 and/or help reduce the magnitude of output interference signal 68. As should be appreciated, output filter 96 could include different electrical components and/or be arranged in a different topology.

As illustrated, both input filter 86 and output filter 96 are constructed using passive components, such as capacitors and resistors. Compared to using active filters, the passive filter construction requires fewer parts and/or facilitates manufacturing filters 84. Active filters typically include additional parts such as operational amplifiers. Such parts increase the complexity of the filters 84 and require connection to a power source. Using passive filter topologies in input filter 86 and output filter 96 allows circuit 70 to be manufactured more effectively and reliably and/or improves the overall power efficiency compared to using active filters.

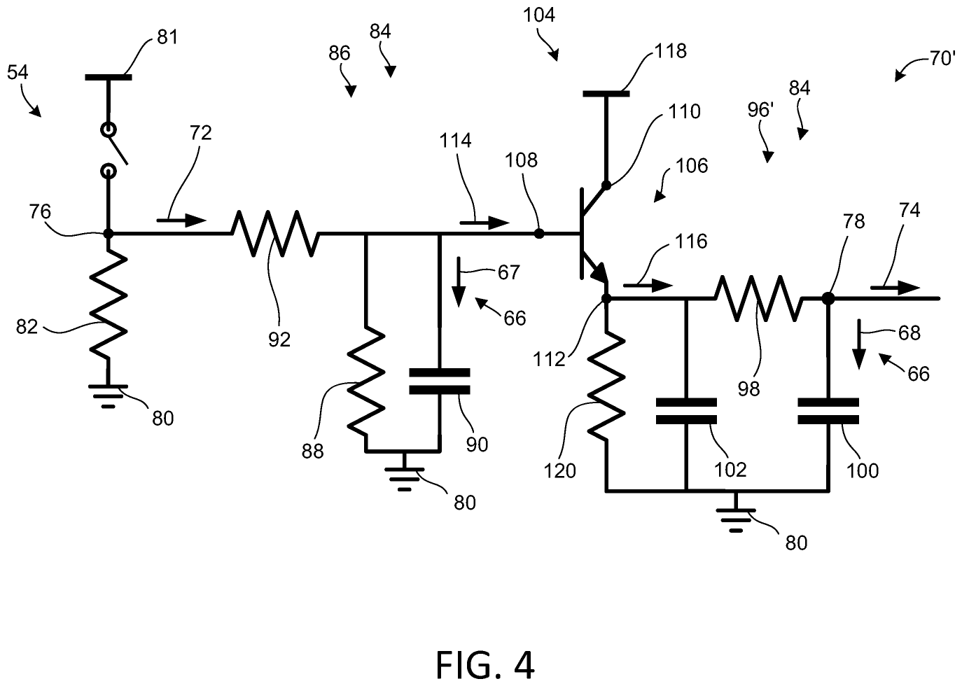

Referring to FIG. 4, an alternative embodiment of circuit 70′ is illustrated. In the FIG. 4 example, output filter 96′ includes a second capacitor 102. In one example, second capacitor 102 is added to lower the cutoff frequency of output filter 96′. In another example, second capacitor 102 is added to make the roll-off of output filter 96′ steeper. By adjusting the cutoff frequency and/or roll-off of output filter 96′, second capacitor 102 allows output filter 96′ to more effectively filter interference signal 66 from circuit 70′. As should be appreciated, input filter 86 and/or output filter 96 could be modified to adjust cutoff frequencies, roll-off steepness, and/or other characteristics. For example, input filter 86 and/or output filter 96 could be modified to more effectively filter a certain range of frequencies of EMI.

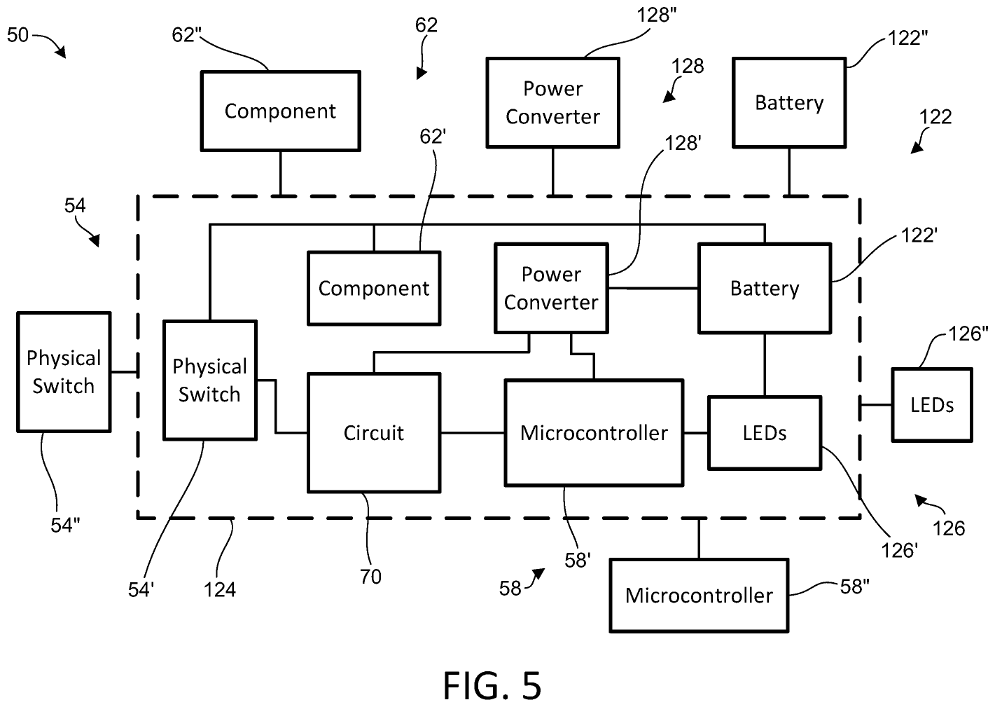

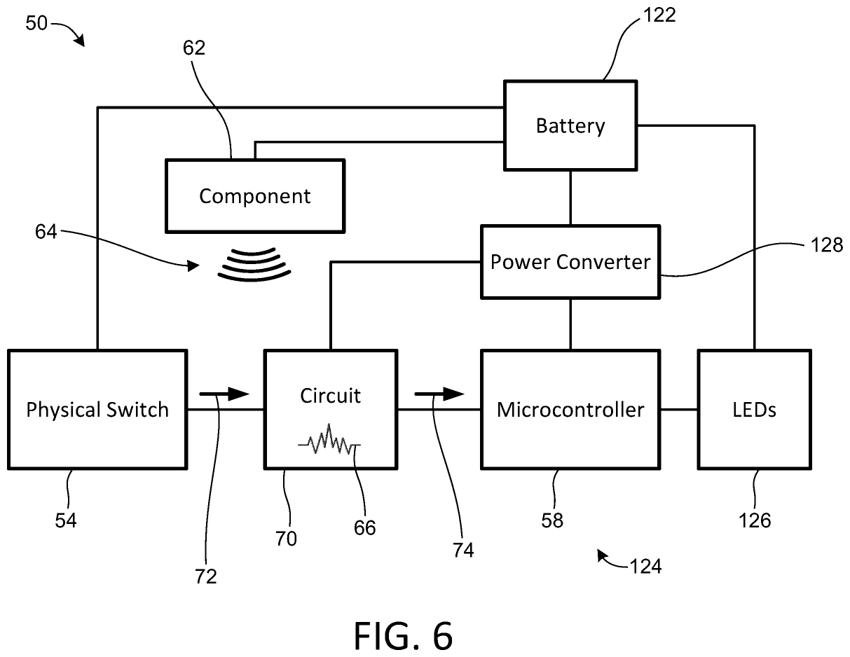

FIGS. 5 and 6 illustrate system 50 with a kit 124 installed. In one embodiment, kit 124 includes one or more LEDs 126 and circuit 70. Optionally, kit 124 further includes physical switch 54 and/or microcontroller 58. In another example, kit 124 further includes a power converter 128 and/or a battery 122. Conversely, system 50 may already include one or more LEDs 126 and kit 124 connects such LEDs 126 to microcontroller 58 and/or battery 122. As illustrated in FIGS. 1 and 6, physical switch 54 is configured to produce circuit input signal 72 based on user inputs and send circuit input signal 72 to circuit 70. Circuit 70 is configured to send circuit output signal 74 to microcontroller 58. Circuit output signal 74 incudes information about user inputs.

Referring to FIG. 5, one or more components may be included in kit 124 and/or already be installed on the system 50. As shown, system 50 may include multiple physical switches 54. Kit 124 can include one or more physical switches 54′. Alternatively, or additionally, system 50 can already include one or more physical switches 54″. When system 50 already includes physical switch 54″, kit 124 can include cables and/or other connectors to connect physical switch 54″ to circuit 70 and microcontroller 58. Similarly, microcontroller 58 may be part of kit 124 or may be already installed in system 50. In one example, kit 124 includes a microcontroller 58′. By including microcontroller 58′ in kit 124, kit 124 can add a variety of functions to system 50. For example, when system 50 is a vehicle such as an ATV or UTV, many new ways to control devices can be possible by adding microcontroller 58′ through kit 124. In another example, system 50 can already include a microcontroller 58″. For instance, one kit 124 may have already been installed on vehicle 50, and another kit 124 can be installed to allow microcontroller 58″ to control additional devices. Kit 124 may include cables and/or other connectors to connect microcontroller 58″ to circuit 70 and other devices in system 50.

As illustrated, LEDs 126 can be part of kit 124 and/or can already be installed on system 50. Kit 124 can include one or more LEDs 126′, such as turn signal lights, console lights to indicate turn signal operation, and/or other lights. System 50 can already include one or more LEDs 126″. In one example, system 50 can include headlights, taillights, console lights and brake lights, and kit 124 can include turn signal lights. As should be appreciated, system 50 and kit 124 could include different types and/or combinations of LEDs 126 (or other types of lights). Further, component 62 can be part of kit 124 and/or can already be installed on system 50. As shown, kit 124 can include one or more components 62′. System 50 can include one or more components 62″ before kit 124 is installed. Kit 124 can include cables and/or other connectors to connect LEDs 126″ and/or component 62″ to microcontroller 58. As should be appreciated, system 50 and/or kit 124 could include any type or combination of types of components 62.

Battery 122 and power converter 128 can be included in kit 124 and/or already be installed in system 50. In one example, kit 124 can include a battery 122′. In another example, system 50 may already include a battery 122″. For instance, system 50 may be an automobile that has a battery 122″. Similarly, kit 124 can include a power converter 128′. Power converter 128′ may be used to convert a voltage from battery 122 to a voltage usable by microcontroller 58 or another device. System 50 may already include a power converter 128″. For example, system 50 may user power converter 128″ to supply power at a desired voltage to one or more other devices in system 50. As should be appreciated, kit 124 and/or system 50 could include either or both battery 122 and power converter 128.

Referring to FIG. 6, LEDs 126 are electrically connected to microcontroller 58. Microcontroller 58 is configured to send a control signal to LEDs 126 to operate LEDs 126 based on a user input. In one example, LEDs 126 are lights in a turn signal on a vehicle. In another example, LEDs 126 include lights used in headlights, taillights, and/or brake lights on a vehicle. In yet another example, LEDs 126 include lights that indicate operation of one or more lights to a user, such as lights in a dashboard and/or console. Microcontroller 58 is configured to operate one or more sets of LEDs 126. For example, microcontroller 58 is configured to blink the LEDs 126 on and off for a number of flashes after receiving user inputs in circuit output signal 74. As should be appreciated, microcontroller 58 can operate the LEDs 126 in another way, such as for a specified period of time.

As illustrated, battery 122 is electrically connected to one or more devices in system 50. Battery 122 is configured to supply power to one or more devices in system 50. In the illustrated example, battery 122 specifically provides power directly to component 62 and LEDs 126. Battery 122 is electrically connected to power converter 128. Power converter 128 is configured to supply power to one or more other devices in system 50. Specifically, power converter 128 is configured to supply power to circuit 70 and microcontroller 58. In one example, input voltage source 81 shown in FIG. 3 includes battery 122, and voltage source 118 shown in FIG. 3 includes power converter 128. Battery 122 is generally configured to supply power through a direct current (DC) voltage, such as at 12 volts. Power converter 128 is configured to supply power through a DC voltage different from battery 122, such as at 5 volts. In the FIG. 5 example, all devices in the system 50 are either directly electrically connected or indirectly electrically connected through one or more other devices.

As illustrated, component 62 can emit electromagnetic waves 64 when activated. As described, electromagnetic waves 64 can cause interference in other devices and/or electrical conductors in system 50. For example, electromagnetic waves 64 can cause interference signals 66 in circuit 70. Interference signals 66 generally affect circuit input signal 72 which carries information about user inputs. As described, interference signals 66 can cause distortion and/or alter circuit input signal 72 in other ways. In one example, electromagnetic waves 64 introduce interference signals 66 in the form of an electrical impulse. The electrical impulse may be interpreted by microcontroller 58 as a user input to activate LEDs 126. In one example, component 62 includes an automobile horn, and honking the horn emits electromagnetic waves 64 which cause interference signals 66. For instance, honking the horn may cause LEDs 126 to activate. Circuit 70 is configured to filter interference signals 66 to prevent unintentional activation of LEDs 126.

In another example, component 62 causes interference in system 50 through one or more conduction paths. As illustrated, component 62 is indirectly electrically connected to one or more other devices through battery 122. The electrical impulse may be interpreted by microcontroller 58 as a user input to activate LEDs 126. In one example, component 62 includes an automobile horn, and honking the horn draws a substantial current from battery 122 which causes ripples in power and creates interference signals 66. Circuit 70 is configured to filter such interference signals 66 to prevent unintentional activation of LEDs 126. Particularly, using the two filters 84 shown in FIG. 3 enables circuit 70 to filter interference signals 66 from multiple causes and/or sources. In an alternate example, component 62 can include a protective circuit that prevents interference caused through conduction. For instance, component 62 may include a reverse voltage diode to prevent current draw after operation.

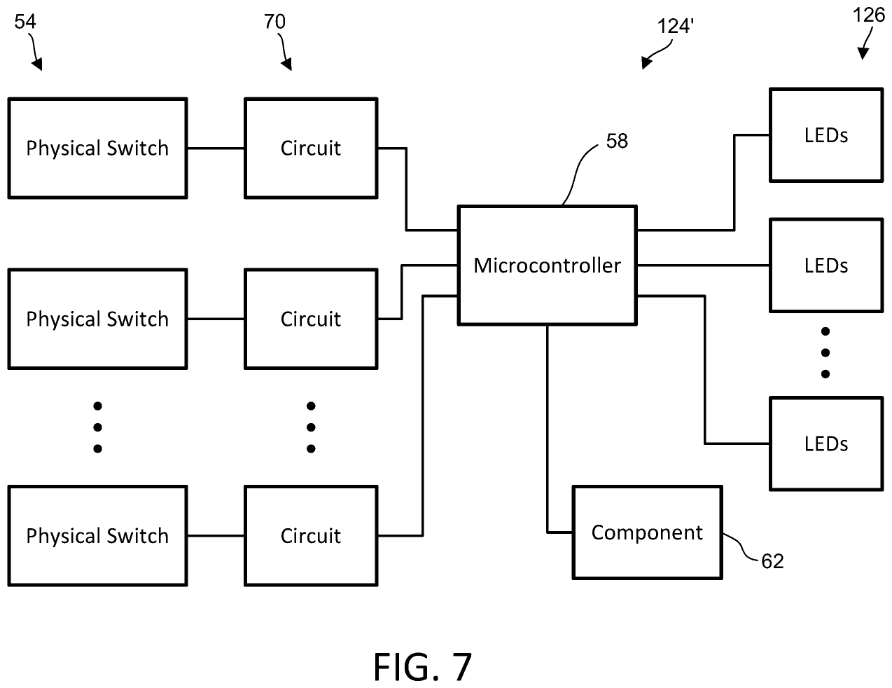

FIG. 7 illustrates another embodiment of kit 124′. As illustrated, kit 124′ generally includes multiple physical switches 54, circuits 70, and LEDs 126. Kit 124′ optionally further includes microcontroller 58 and/or component 62. Each physical switch 54 is generally configured to generate a control signal based on user inputs. Each physical switch 54 is typically configured to send the control signals to microcontroller 58. Microcontroller 58 is configured to control the multiple sets of LEDs 126 and/or component 62 based on user inputs provided through the multiple physical switches 54. In the illustrated example, one physical switch 54 corresponds to one control line used to control one set of LEDs 126 or component 62. In another example, one physical switch 54 is configured to send different control signals on multiple control lines used to control multiple sets of LEDs 126. For instance, one or more physical switches 54 may include a rocker switch and/or selector switch that is configured to provide an output at multiple nodes.

Kit 124′ incudes one circuit 70 on each control line. In the illustrated example, one circuit is connected between each physical switch 54 and microcontroller 58. In another example, multiple circuits 70 can be connected between a single physical switch 54 and microcontroller 58, such as one circuit 70 on each control line between physical switch 54 and microcontroller 58. Circuits 70 are configured to filter interference from each control line such that each user input is transmitted as intended to microcontroller 58. For example, circuit 70 ensures that each electrical signal received at microcontroller 58 from any physical switch 54 is substantially free of distortion and/or noise.

Using microcontroller 58 allows system 50 to control LEDs 126, components 62, and/or other devices in a variety of ways. Microcontroller 58 generally allows a higher degree of precision, complexity, and/or customization for controlling devices compared to a relay or another such device. For example, some systems, such as an ATV, UTV, or another vehicle, may only include relays and not microcontroller 58 to control one or more devices. Controlling devices in such vehicles can be limited to simple operations. Further, microcontroller 58 facilitates expanding the number of LEDs 126 and/or components 62 on system 50. For instance, microcontroller 58 can receive multiple inputs via one or more physical switches 54 and can send multiple different outputs to one or more LEDs 126 and/or components 62. Conversely, a relay or similar device may only produce one output signal in response to an input, and multiple relays are generally needed to control multiple devices in response to multiple inputs. Using microcontroller 58 allows a user to efficiently install additional LEDs 126 and/or components 62, such as through kit 124′. Microcontroller 58 similarly facilitates installing additional physical switches 54 and circuits 70. Microcontroller 58 allows a user to add or adjust functionality of one or more LEDs 126 and/or components 62 without needing additional devices. For example, microcontroller 58 allows a user to operate various LEDs 126 and/or other components 62 in multiple different ways in response to different inputs.

The number of physical switches 54, circuits 70, LEDs 126, and/or components 62 is customizable in kit 124′. Optionally, kit 124′ can include multiple microcontrollers 58 and/or one or more other devices. The number of LEDs 126 can be varied to provide all the lights necessary for a vehicle. For example, the LEDs 126 can be arranged into various sets that correspond to headlights, taillights, brake lights, hazard lights, console lights, and/or turn signals in a vehicle. Further, kit 124′ can include and/or be used to connect one or more components 62 to microcontroller 58. For example, kit 124′ can include or be configured to connect to an automobile horn and/or another device. In another example, kit 124′ is configured to connect microcontroller 58 to one or more LEDs 126 already in a vehicle. In yet another example, kit 124′ is configured to connect microcontroller 58 to a hydraulic actuator, an electric motor, and/or another device. For instance, kit 124′ may connect microcontroller 58 to such devices as used in a dump bed, winch, and/or another device installed on system 50.

While the present disclosure has been illustrated and described in detail in the drawings and foregoing description, the same is to be considered as illustrative and not restrictive in character, it being understood that a preferred embodiment has been shown and described and that all changes, equivalents, and modifications that come within the spirit of the claimed invention defined by following claims are desired to be protected. All publications, patents, and patent applications cited in this specification are herein incorporated by reference as if each individual publication, patent, or patent application were specifically and individually indicated to be incorporated by reference and set forth in its entirety herein.

The language used in the claims and the written description and in the above definitions is to only have its plain and ordinary meaning, except for terms explicitly defined above. Such plain and ordinary meaning is defined here as inclusive of all consistent dictionary definitions from the most recently published (on the filing date of this document) general purpose Merriam-Webster dictionary.

1. A circuit for connecting a first component and a second component, the circuit comprising:
a switch comprising a control node, an input node, and an output node, wherein said switch is adapted to receive a switch control signal at said control node and is adapted to output a switch output signal at said output node;
a first filter between said control node and said first component, wherein said first filter is adapted to receive a circuit input signal from the first component, said circuit input signal including said switch control signal, wherein said first filter is adapted to at least partially filter an interference signal from said circuit input signal and to pass said switch control signal to said control node on said switch; and
a second filter between said output node of said switch and said second component, wherein said second filter is adapted to receive said switch output signal from said switch, wherein said second filter is adapted to filter said interference signal from said switch output signal and to pass a circuit output signal to the second component.

2. The circuit of claim 1, wherein said first filter is a low-pass filter, and wherein a frequency of said switch control signal is lower than a frequency of said interference signal.

3. The circuit of claim 2, wherein said first filter comprises a resistor and capacitor connected in parallel.

4. The circuit of claim 1, wherein said second filter is a low-pass filter, and wherein a frequency of said circuit output signal is lower than a frequency of said interference signal.

5. The circuit of claim 4, wherein said second filter comprises a resistor and a capacitor, wherein said resistor is between said output node and said second component, and wherein said capacitor is between said second component and a ground node.

6. The circuit of claim 4, wherein said first filter is a low-pass filter, and wherein a cutoff frequency of said second filter is lower than a cutoff frequency of said first filter.

7. The circuit of claim 4, wherein said first filter is a low-pass filter, and wherein a cutoff frequency of said first filter and a cutoff frequency of said second filter are both below 200 Hz.

8. The circuit of claim 1, wherein said second filter is adapted to filter a second interference signal from said switch output signal, and wherein said second interference signal is present at said output node and not at said input node of said switch.

9. The circuit of claim 1, wherein a frequency of said interference signal is greater than 100 Hz.

10. The circuit of claim 1, wherein said interference signal is at least partially caused by electromagnetic waves.

11. The circuit of claim 1, wherein the first component comprises a physical switch, wherein operating the physical switch changes said circuit input signal, and wherein said first filter is adapted to filter bounce oscillations from said circuit input signal caused by the physical switch.

12. The circuit of claim 1, wherein the second component comprises a microcontroller, and wherein the microcontroller is adapted to control one or more other components based on said circuit output signal.

13. The circuit of claim 12, wherein said first and second filters are adapted to delay said circuit output signal less than 100 milliseconds relative to said circuit input signal between the first component and the microcontroller.

14. The circuit of claim 1, wherein said circuit and the first and second components are installed in a vehicle, wherein the vehicle comprises a third component, and wherein the third component produces said interference signal.

15. The circuit of claim 1, wherein said first filter comprises a shunt resistor, wherein said first filter is adapted to reduce a voltage amplitude of said circuit input signal using said shunt resistor.

16. The circuit of claim 1, wherein said switch is adapted to change a voltage level of said switch control signal, and wherein a voltage amplitude of said switch control signal is different than a voltage amplitude of said switch output signal.

17. The circuit of claim 16, wherein a voltage amplitude of said circuit input signal is based on a voltage level of a battery in the vehicle, and wherein a voltage amplitude of said circuit output signal is based on a usable voltage amplitude of an input for a microcontroller.

18. The circuit of claim 16, wherein a voltage amplitude of said switch control signal is higher than a voltage amplitude of said switch output signal, and wherein said switch is adapted to lower a voltage level of said switch control signal.

19. A kit for installing a turn signal in a vehicle, said kit comprising:
a physical switch;
a microcontroller;
one or more lights operatively connected to said microcontroller;
said circuit of claim 1 connecting said physical switch and said microcontroller, wherein said first filter is adapted to receive said circuit input signal from said physical switch, and wherein said second filter is adapted to pass said circuit output signal to said microcontroller; and
wherein operating said physical switch changes said circuit input signal, and wherein said microcontroller is configured to operate said lights based on said circuit output signal.

20. The kit of claim 19, wherein the vehicle includes a component that produces said interference signal.

21. The kit of claim 20, wherein the component is a horn.

22. The kit of claim 20, wherein the component generates electromagnetic waves, and wherein said interference signal is at least partially caused by the electromagnetic waves generated by the component.
